(19) United States
(12) Patent Application Publication
(10) Pub. No.: US 2026/0037219 A1
(43) Pub. Date: Feb. 5, 2026

(54) SYSTEM AND METHOD TO ACCELERATE ARRAY OPERATIONS

(71) Applicant: Arith Inc., Palo Alto, CA (US)

(72) Inventor: David H.C. Chen, Palo Alto, CA (US)

(21) Appl. No.: 18/793,612

(22) Filed: Aug. 2, 2024

(51) Int. Cl. G06F 7/523; G06F 7/50

(52) U.S. Cl. CPC G06F 7/523; G06F 7/50

(57) ABSTRACT

Systems and methods are directed to accelerating array operations associated with an integrated circuit. The integrated circuit comprises at least one multiply-adder configured to receive a first multiplicand, a second multiplicand, and an addend and to perform an operation to generate an output. The multiply-adder comprises one or more multipliers that multiply the first multiplicand with the second multiplicand to generates a product. The multiply-adder also comprises one or more adders that add the product with the addend to generate a sum. A selector of the multiply-adder then selects the output based on whether the first multiplicand, the second multiplicand, and/or the addend is zero, infinity, non-numeric or finite non-zero.

### TECHNICAL FIELD

The subject matter disclosure herein generally relates to integrated circuits. Specifically, the present disclosure addresses integrated circuits that comprise an array coprocessor that accelerates array operations.

### BACKGROUND

Conventionally, computing devices are used to perform operations that are used in countless applications. As an example, tensor operations are essential and critical for artificial intelligent (AI) applications. However, array, matrix, vector, and tensor operations require processors (e.g., central processing units (CPUs) and graphics processing units (GPUs)) to conduct billions of computations and data movements. This results in consumption of significant power. Consequently, AI applications are performed today at power-hungry datacenters with personal data transferred over the Internet.

### BRIEF DESCRIPTION OF THE DRAWINGS

Some embodiments are illustrated by way of example and not limitation in the figures of the accompanying drawings.

FIG. 1 is a diagram illustrating an exemplary integrated circuit comprising a multiply-adder configured to accelerate computations, according to some example implementations.

FIG. 2 is a diagram illustrating an exemplary integrated circuit comprising a chained multiply-adder configured to accelerate computations, according to some example implementations.

FIG. 3 is a diagram illustrating an exemplary integrated circuit comprising a matrix multiply-adder configured to accelerate computations, according to some example implementations.

FIG. 4 is a diagram illustrating an exemplary integrated circuit comprising a post-processor configured to accelerate computations, according to some example implementations.

FIG. 5 is a diagram illustrating an exemplary integrated circuit comprising a circuitry module configured to accelerate computations, according to some example implementations.

FIG. 6 is a flow diagram illustrating a method for accelerating computations, in accordance with example implementations.

FIG. 7 is a block diagram illustrating components of a machine, according to some example embodiments, able to read instructions from a machine-storage medium and perform any one or more of the methodologies discussed herein, according to some example implementations.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Example implementations provide a technical solution for dealing with the technical problem of accelerating operations associated with a microprocessor. Specifically, example systems and methods accelerate array computations. The systems and methods are suitable for arithmetic operations on integer, fixed-point, block floating-point, and/or floating-point operands in their uncompressed or compressed formats. Furthermore, input and output operands are allowed to be in different formats. By using example implementations to accelerate computations, one or more of the methodologies described herein may obviate a need for certain efforts or computing resources that otherwise would be involved in conventional computational devices. Examples of such computing resources comprise processor cycles, memory usage, data storage capacity, and power consumption.

As discussed above, AI applications are typically performed at power-hungry datacenters with personal data transferred over the Internet. To enable inexpensive battery-power mobile devices to perform AI applications locally and to preserve data security and personal privacy, example implementations provide an array coprocessor with higher energy efficiency and less initial hardware costs. Using architectures such as RVA23 or similar, the array coprocessor can be directly integrated as an extension of a main processor core sharing a unified Instruction Set Architecture (ISA) and ensuring seamless communication, resource sharing (e.g., memory, cache, register file, buffer and scratchpad), and task delegation between the main processor and array coprocessor.

Alternatively, the main processor and array coprocessor can be coupled via a high-speed interconnect. For example, a PCIe (Peripheral Component Interconnect Express) bus, a memory bus, or a network-on-chip interconnect in a System-on-Chip (SoC) design can be used. It is also possible to integrate the main processor and the array coprocessor as chiplets (e.g., potentially individually optimized and manufactured using different process nodes) into a single chip using advanced packaging technologies (e.g., Chip-on-Wafer-on-Substrate (CoWoS)). The main processor may utilize Application Programming Interfaces (APIs) or specialized primitives (e.g., an instruction set) to dispatch tasks to the array coprocessor.

Thus, example implementations allow for any suitable integration and communication for sharing data between the main processor and the array coprocessor. For simplicity, all figures discussed herein omit the communication and potentially shared resources (e.g., memory, cache, register file, buffer and scratchpad) between the main processor and the array coprocessor. The array coprocessor is discussed in terms of exemplary integrated circuits below.

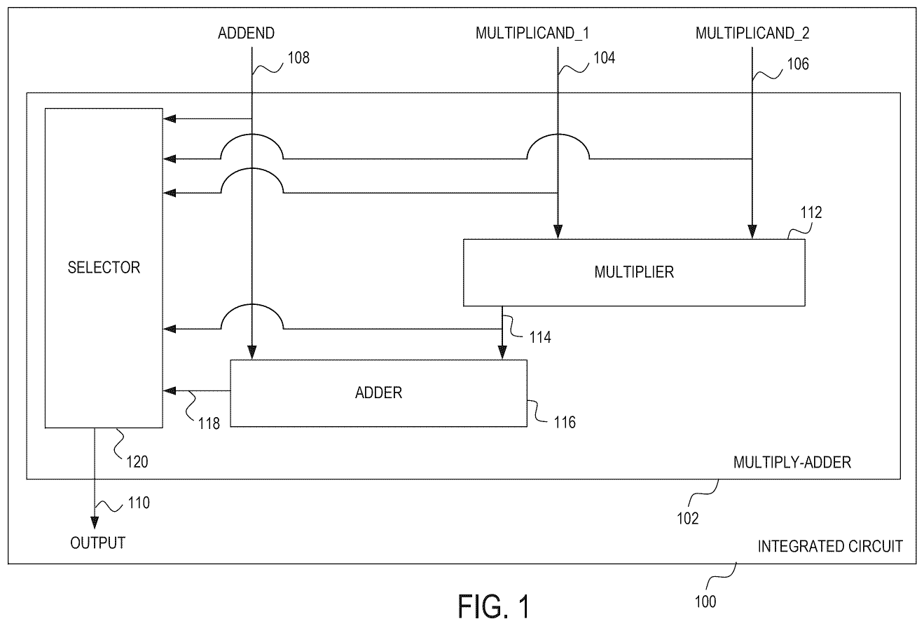

FIG. 1 illustrates an exemplary integrated circuit 100 comprising a multiply-adder 102 configured to accelerate computations, according to some example implementations. The multiply-adder 102 receives a first multiplicand (multiplicand_1) 104, a second multiplicand (multiplicand_2) 106, and an addend 108, and performs an operation to generate an output 110. The multiply-adder 102 comprises a multiplier 112 that multiplies the first multiplicand 104 with the second multiplicand 106 to generate a product 114. An adder 116 adds the product 114 with the addend 108 to generate a sum 118. A selector 120 then selects the output 110.

In example implementations, the selector 120 determines the output 110 based on conditions of the inputs (e.g., the first multiplicand 104, the second multiplicand 106, and/or the addend 108). If the first multiplicand 104, the second multiplicand 106, or the addend 108 is non-numeric (e.g., Not a Number (NaN) as standardized by IEEE Std 754), the selector 120 can select the non-numeric as the output 110, and the multiplier 112 and the adder 116 can skip computations to save energy. Alternatively, if one of the first multiplicand 104 or the second multiplicand 106 is zero while the other is finite, the selector 120 can select the addend 108 as the output 110, and the multiplier 112 and the adder 116 can skip computations to save energy. Further still, if the addend 108 is zero, the selector 120 can select the product 114 as the output 110, and the adder 116 can skip computation to save energy. If the product 114 is infinite and the addend 108 is finite, the selector 120 can select the product 114 as the output 110, and the adder 116 can skip computation to save energy. Otherwise, the selector 120 can select the sum 118.

In some implementation, the first multiplicand 104 can be a floating-point number while the second multiplicand 106 can be an integer number. Conversely, the first multiplicand 104 can be an integer number while the second multiplicand 106 can be a floating-point number. The integer input can be considered as a fixed-point number with a predetermined or implicit radix point. With such consideration, a floating-point number can be multiplied with the integer.

In some implementations, the first multiplicand 104, the second multiplicand 106, or both can be an unsigned floating-point number that includes an exponent field and a significand field, but no sign bit. When either multiplicand (104 or 106) lacks a sign, it can be considered as having an implicit positive sign and computation can be conducted based on such consideration.

In some implementations, the addend 108 can be an integer number, floating-point number, or unsigned floating-point number. For computation, an integer input can be considered as a fixed-point number with a predetermined or implicit radix point, while an unsigned floating-point number can be considered as having an implicit positive sign.

The precision of the output 110 can be equal to or different from the precision of the addend 108. Additionally, the format or type of the output 110 may be the same as or different from that of the addend 108. Integer, fixed-point, floating-point, block floating-point, and unsigned floating-point are some examples of possible formats or types.

In some implementations, the first multiplicand 104 is a floating-point number with a first precision, and the second multiplicand 106 is a floating-point number with a second precision. Here, the first precision and the second precision can differ from each other. In such situations, the multiplier 112 can deploy an internal precision capable of handling precisions of both multiplicands 104 and 106 and their product 114. For example, the first multiplicand 104 is with a 4-bit exponent and a 4-bit precision while the second multiplicand 106 is with a 5-bit exponent and a 3-bit precision, the multiplier can be configured to have at least a 5-bit exponent and at least a 4-bit precision to accommodate both multiplicands.

In some cases, the precision of the output 110 can be higher than the precisions of both the first multiplicand 104 and the second multiplicand 106. This will help preserve the precision of the product 114. In some cases, the precision of the product 114 is the sum of the precisions of both the first multiplicand 104 and the second multiplicand 106.

In some cases, the output 110 can be an integer, a fixed-point, a floating-point, or an unsigned floating-point. An integer number may be able to represent an exact mathematical result of computation without any error potentially caused by truncation or rounding. In some cases, the output 110 is clamped to a predetermined range. For example, a value with a positive or negative maximum finite number (instead of an infinity) is generated as the output 110. Another example is that a value with a positive or negative minimum finite non-zero (instead of zero) is generated as the output 110.

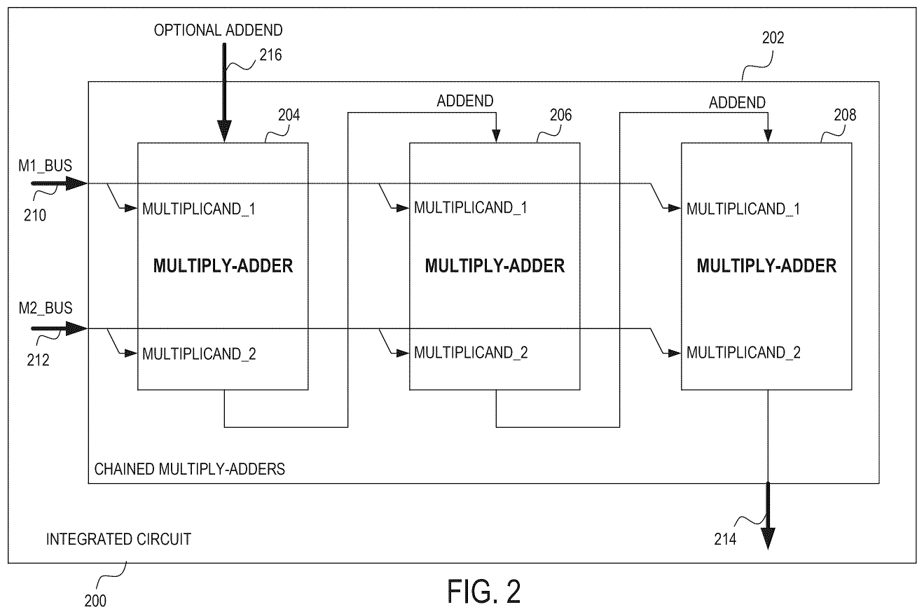

FIG. 2 illustrates an exemplary integrated circuit 200 comprising a chained multiply-adder 202 configured to accelerate computations, according to some example implementations. Example implementations can arrange at least two multiply-adders (e.g., multiply-adders 102) as a chain. The length of the chain can match a preferred or predetermined one-dimensional (1D) array size or a SIMD (single-instruction multiple-data) machine size for optimal 1D array operations. For clarity, FIG. 2 shows three multiply-adders 204, 206, 208, although there is no limitation to the number of multiply-adders inside the chained multiply-adder 202.

Example 1 exemplifies a dot product computation in Python language that can be performed with the chained multiply-adders 202. Array A comprises three elements [1, 2, 3], while Array B comprises another three elements [4, 5, 6]. Array A is transmitted via m1_bus 210, while Array B is transmitted via m2_bus 212. Multipliers inside the multiply-adders 204, 206, 208 perform 1*4, 2*5, and 3*6, respectively, in parallel. The output 214 is available immediately.

### Example 1: Dot Product (in Python Language)

$$a = np . array ( [ 1 , 2 , 3 ] )$$

$$b = np . array ( [ 4 , 5 , 6 ] )$$

$$dot\_product = np . dot ( a , b )$$

$$print ( dot\_product ) \# Output : 32 ( 1 * 4 + 2 * 5 + 3 * 6 )$$

As such, the multiplicand_1 provided to the first multiply-adder 204 is 1 and the multiplicand_2 provided to the first multiple-adder 204 is 4, resulting in the first multiply-adder 204 performing a calculation 1*4. The multiplicand_1 provided to the second multiply-adder 206 is 2 and the multiplicand_2 provided to the second multiple-adder 206 is 5, resulting in the second multiply-adder 206 performing a second calculation 2*5. Finally, the multiplicand_1 provided to the third multiply-adder 208 is 3 and the multiplicand_2 provided to the third multiple-adder 208 is 6, resulting and the third multiply-adder 208 performing a third calculation 3*6.

A select output of each multiply-adder is passed to the next multiply-adder in the chain, where it will be added to the result of the calculation performed by the next multiply-adder. Thus, for example, the first multiply-adder 204 will pass its select output (e.g., 1*4=4) to the second multiply-adder 206 which will add the select output from the first multiply-adder 204 with its own result (e.g., 4+ (2*5)=14). This select output is then passed to the third multiply-adder 208 which will add it to its own result (e.g., 14+ (3*6)=32) to generate the output 214.

While FIG. 2 illustrates one implementation of the chained multiply-adder 202, alternative implementations can modify one or more components of the chained multiply-adder 202. For example, the chained multiply-adder 202 can have all multiply-adders 204, 206, 208 share only one adder which is configured to sum up all the products at once. Additionally, an addend input 216 is optional and can be hardwired to be zero in some implementations. Furthermore, the selector 120 in FIG. 1 can be omitted from one or more of the multiply-adders 204, 206, and/or 208. In this case, the sum 118 is the output (e.g., the select output).

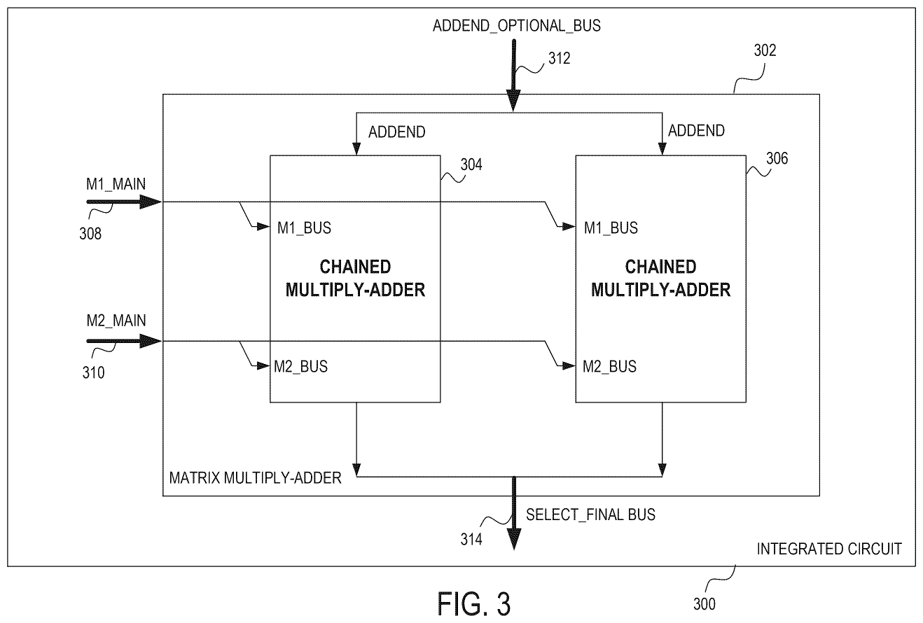

FIG. 3 illustrates an exemplary integrated circuit 300 comprising a matrix multiply-adder 302 configured to accelerate computations, according to some example implementations. Example implementations can arrange at least two chained multiply-adders (e.g., chained multiply-adders 202) to form the matrix multiply-adder 302. The number of chained multiply-adders can be equal to or different from a length of the chained multiply-adders. In this way, any rectangular or square two-dimensional (2D) matrix is possible (e.g., 2×2, 3×4 or 3×2). A 3×4 matrix multiply-adder, for example, will comprise four chained multiply-adders, each comprising three multipliers (e.g., multiply-adders), resulting in a total of twelve multipliers. In contrast, a 3×2 matrix multiply-adder 302, as shown in FIG. 3, will comprise two chained multiply-adders 304 and 306, each comprising three multipliers (e.g., multiply-adders), resulting in a total of six multipliers. The select final bus 314 carries outputs from each and every chained multiply-adder (e.g., the chained multiply-adders 304 and 306).

The matrix multiply-adder 302 can be configured to further receive data from an optional addend bus 312. The optional addend bus 312 may provide either a residue (e.g., the input of a network layer) or a bias. Residual addition enables casier training of deeper neural networks (e.g., Residual Networks (ResNets) and Transformers) with gradients flowing more directly through the network. In some cases, the matrix multiply-adder 302 can perform residue and/or bias addition(s). In other cases, a post-processor can perform residue and/or bias addition(s). Yet, in other cases, the matrix multiply-adder 302 can perform one of residue and bias additions, while the post-processor can perform the other. Residue and bias additions are similar. In Example 2, the optional addend bus 312 is not utilized or connected to zero, and the post-processor performs bias addition.

Example 2 is an example of a fully connected (dense) layer multiplication. In this example, the 3×2 matrix multiply-adder 302 is utilized to accelerate multiplication with minimized data movement for optimal performance and energy efficiency.

### Example 2: Matrix Multiplication, Bias Addition, and Activation Function

$$Input X = [ 2 , 1 , 3 ]$$

$$Weight W = [ [ 0.1 , 0.2 ] , [ 0.3 , 0.4 ] , [ 0.5 , 0.6 ] ]$$

$$Bias vector : b = [ 0.1 , - 0.1 ]$$

$$X \cdot W = [ 2 , 1 , 3 ] \cdot [ [ 0.1 , 0.2 ] , [ 0.3 , 0.4 ] , [ 0.5 , 0.6 ] ] = [ ( 2 * 0.1 + 1 * 0.3 + 3 * 0.5 ) , ( 2 * 0.2 + 1 * 0.4 + 3 * 0.6 ) ] = [ 2. , 2.6 ]$$

$$[ 2. , 2.6 ] + [ 0.1 , - 0.1 ] = [ 2.1 , 2.5 ] \qquad ( adding the bias vector to the sum )$$

$$Re LU ( [ 2.1 , 2.5 ] ) = [ 2.1 , 2.5 ] \qquad ( Re LU is used as an activation function )$$

Input X is a 1D array with three elements which are transmitted via m1_main 308, while a weight W is a 2D matrix which is transmitted via m2_main 310. The two multipliers on a first row receive 2 (e.g., a first element of X); both multipliers on a second row receive 1 (e.g., a second element of X); and both multipliers on the last row receive 3 (e.g., a third element of X), as their respective first multiplicands. As their respective second multiplicands, each of the six multipliers receive a different respective element from the weight W, which is a 2D 3×2 matrix.

All six multipliers perform multiplications in parallel to generate products of 2*0.1, 1*0.3, 3*0.5, 2*0.2, 1*0.4, 3*0.6. Immediately, a three-input adder inside chained multiply-adder 304 sums up 0.2, 0.3, 1.5 to generate 2.0, while another three-input adder inside chained multiply-adder 306 sums up 0.4, 0.4, 1.8 to generate 2.6. Together, the sum [2.0, 2.6] is generated with both chained multiply-adders 304 and 306.

In some cases, a bias addition and an activation function are applied to the sum. As an example, ReLU (Rectified Linear Unit) is used as an exemplifying activation function. After the bias addition, both values 2.1 and 2.5 are positive, so ReLU does not change the values. A final output of this fully connected layer is [2.1, 2.5]. The bias addition and activation function are both performed by a post-processor which will be discussed in further detail below.

Example implementations support at least two types of activation functions. A first type of activation functions is functions of one fold x, comprising, for example, ReLU (Rectified Linear Unit), Sigmoid, Tanh (Hyperbolic Tangent), Leaky ReLU, ELU (Exponential Lincar Unit), SELU (Scaled Exponential Lincar Unit), and/or Swish. A second type of activation functions is not functions of a single fold x, comprising, for example, Softmax and Maxout.

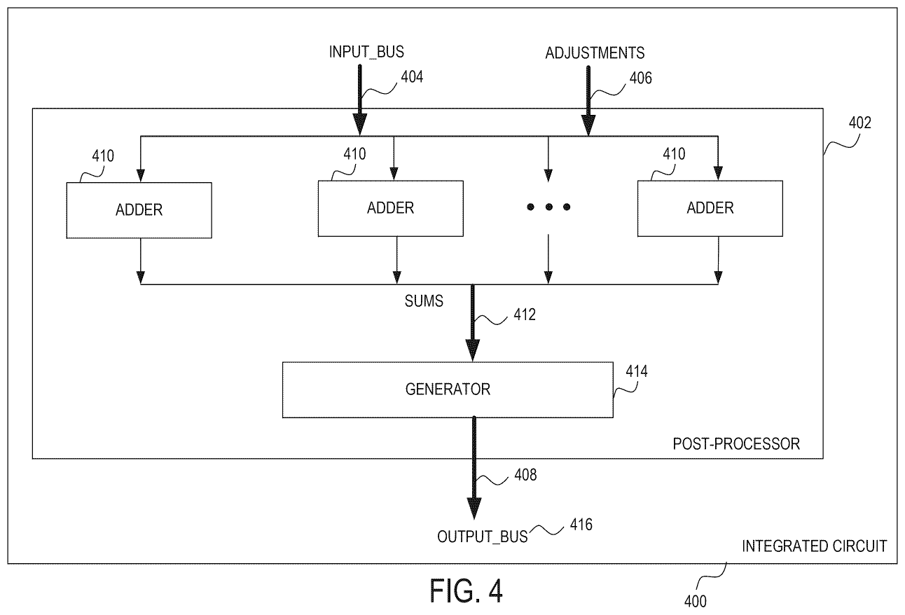

FIG. 4 illustrates an exemplary integrated circuit 400 comprising a post-processor 402 configured to accelerate computations, according to some example implementations. The post-processor 402 receives at least two inputs—at least one input from an input bus 404 and at least one adjustment 406 and performs an operation to generate an output 408. In some cases, the at least one input comprises the output(s) 314 from the matrix multiply-adder 302 of FIG. 3. The at least one adjustment can be a residue from a prior layer (e.g., in case of ResNets or Transformers), a predetermined bias (e.g., resulting from AI training, as in Example 2), or a precomputed scaling factor (e.g., as in Example 4 below). The post-processor 402 comprises at least two adders 410 that each receives the input(s) from the input bus 404 and the adjustment(s) 406 and generates at least two sums 412 (e.g., a sum from each adder 410). The post-processor 402 also includes a generator 414 that produces the output 408 based on the sums 412. An output bus 416 is configured to transmit the output 408.

In example implementations, the at least two adders 410 can produce the at least two sums 412 by either modifying an exponent of at least one of the inputs from the input bus 404 based on the adjustment 406 or by adding the adjustment 406 to at least one of the inputs. The adjustment 406 can be used to scale the sums 412 into a predetermined and preferrable range. If the input from the input bus 404 is in integer or fixed-point format, the implicit exponent can be scaled. Alternatively, the adjustment 406 can be used to add a bias into at least one of the inputs as shown in Example 2. The adders 410 can add the bias in a programmed computation cycle and can perform scaling in another programmed computation cycle. In various implementations, the adders 410 can perform neither addition nor scaling, addition only, scaling only, or both addition and scaling. Alternatively, the adders 410 can forward the adjustment 406 to the generator 414. In one implementation, the exponent scaling mechanism can be utilized to support, for example, E8M0 scale data type as specified by OCP Microscaling Formats (MX) Specification. The adjustment 406 can be in various formats, such as integer, fixed-point, floating-point, unsigned floating-point, E8M0 as specified by OCP Microscaling Formats (MX) Specification, or logarithmic number. In some cases, the adjustment 406 is of the same format as the at least two outputs 408.

In some implementations, the generator 414 receives the sums 412 and generates at least two outputs 408 by performing operations such as, for example, truncation, rounding, table look-up, function estimation, filtering, negation, sign bit resetting, and/or forwarding. The generator 414 can truncate the sums 412 by omitting at least one least significand bit. The generator 414 can round the sums 412 according to a rounding attribute (e.g., round to the nearest) as standardized by IEEE Std 754, stochastically (e.g., rounding the sums 412 with a rounding decision determined randomly, based on a value of digits following the rounding position), or a different method. Based on the sums 412, the generator 414 can look up a predetermined table (not shown) to approximate a mathematical function (e.g., Sigmoid, Tanh, Leaky ReLU, ELU, SELU, and/or Swish). Based on the sums 412, the generator 414 can estimate a mathematical function (e.g., exponential). The generator 414 can also filter the sums 412 to produce a ReLU result, by outputting the sums 412 directly if positive or zero otherwise. The generator 414 can negate the sums 412 to produce results with an opposite sign. The generator 414 can also reset any sign bits of the sums 412 to produce absolute values. Additionally, the generator 414 can simply forward the sums 412 without modification.

There are several methods to produce the output 408. First, the generator 414 can arrange the at least two sums 412 in order of their numerical values, sorting from either the largest to the smallest number or from the smallest to the largest number. Alternatively, the generator 414 can produce the output 408 by either summing or averaging the at least two sums 412. Summation and averaging are useful functions especially for convolution neural networks (CNNs). Additionally, the generator 414 can produce the output 408 by altering the arrangement of the at least two sums 412 through transposing, permuting, shuffling, sampling, and/or forwarding. The generator 414 can utilize shared memory, cache, register file, buffer, scratchpad, or other resources to conduct any of those functions. Transposing a matrix involves flipping it over its diagonal and swapping its rows with its columns. Furthermore, the generator 414 can convert the at least two sums 412 into a predetermined format. Finally, the generator 414 can simply forward the at least two sums 412. In some cases, the generator 414 clamps the output 408 to a predetermined range. For example, the generator 414 generates a value with a positive or negative maximum finite number, instead of an infinity. Additionally or alternatively, the generator 414 generates a value with a positive or negative minimum finite non-zero, instead of a zero.

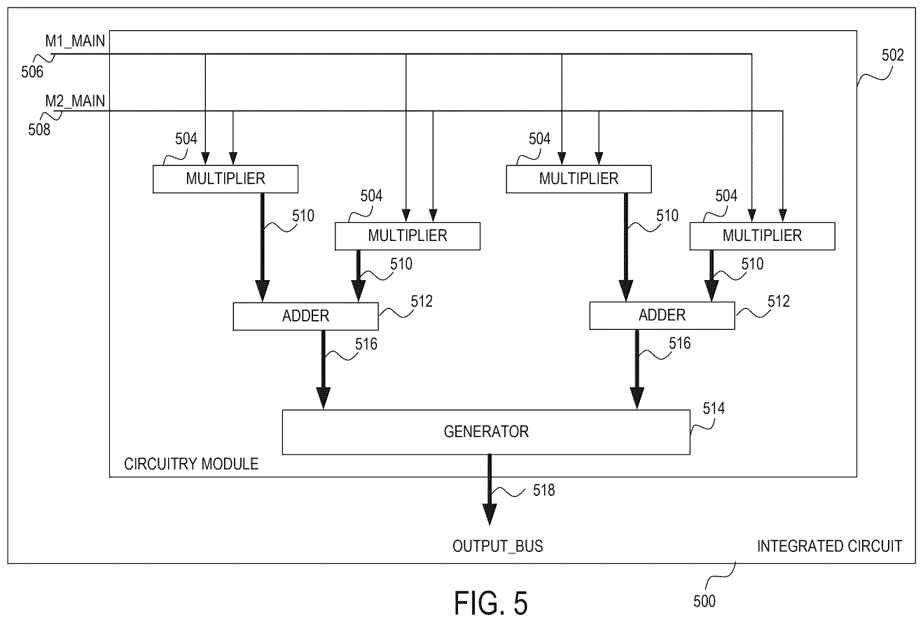

FIG. 5 illustrates an exemplary, simplified integrated circuit 500 comprising a circuitry module 502 configured to accelerate computations, according to some example implementations. The simplified integrated circuit 500 can be a simplified version of the integrated circuit 300 and the integrated circuit 400. The circuitry module 502 comprises at least four multipliers 504. Each of the at least four multipliers 504 receives a first multiplicand from m1_main bus 506 and a second multiplicand from m2_main bus 508. From the m1_main bus 506, the at least four multipliers 504 can receive the same or different data as their first multiplicands. Similarly, the at least four multipliers 504 can receive the same or different data as their second multiplicands from the m2_main bus 508. This configuration offers high flexibility for the at least four multipliers 504 to perform various matrix operations (e.g., dot product, matrix multiplication, inner product, and/or convolution). The at least four multipliers 504 perform programmed operations and generate at least four products 510.

The circuitry module 502 further comprises at least two adders 512, and a generator 514. One of the at least two adders 512 sums up a pair of the at least four products 510. The other of the least two adders 512 sums up another pair, such that the at least two adders 512 generate at least two sums 516. The generator 514 receives the at least two sums 516 and generates an output 518 based on the at least two sums 516.

Optionally, the circuitry module 502 further receives an adjustment (not shown). One of the at least two adders 512 sums up a pair of the at least four products 510 and the adjustment, or sums up the pair of the at least four products 510 and adjusts the resulting exponent based on the adjustment. The other of the least two adders 512 sums up another pair of the at least four products 510 and the adjustment, or sums up another pair of the at least four products 510 and adjusts the resulting exponent based on the adjustment. The generator 514 then receives the at least two sums 516 from the at least two adders 512 and generates the output 518 based on the at least two sums 516. In some cases, the generator 514 clamps the output 518 to a predetermined range. For example, the generator 514 generates a value with a positive or negative maximum finite number, instead of an infinity. Additionally or alternatively, the generator 514 generates a value with a positive or negative minimum finite non-zero, instead of a zero. The adjustment (not shown) can be in various formats, such as integer, fixed-point, floating-point, unsigned floating-point, E8M0 as specified by OCP Microscaling Formats (MX) Specification, or logarithmic number. In some cases, the adjustment (not shown) is of the same format as the output 518.

In some cases, the first multiplicands from the m1_main bus 506 can be floating-point numbers with a specified precision, while the second multiplicands from the m2_main bus 508 can also be floating-point numbers but with a different precision. In some implementations, the precision of the output 518 generated by the circuitry module 502 can be higher than the precisions of both the first multiplicands from the m1_main bus 506 and the second multiplicands from the m2_main bus 508.

In some cases, the first multiplicands from the m1_main bus 506 can be floating-point numbers and the second multiplicands from the m2_main bus 508 can be integer numbers. Conversely, the first multiplicands from the m1_main bus 506 can be integer numbers and the second multiplicands from the m2_main bus 508 can be floating-point numbers. Furthermore, the first multiplicands, the second multiplicands, or both can be unsigned floating-point numbers characterized by an exponent field and a significand field and with no signed bits. Example implementations can treat unsigned floating-point numbers as positive floating-point numbers with an implicit positive sign.

Example 3 shows how four instances of the circuitry module 502 perform convolution. In this example, each circuitry module 502 is configured with 2×2 multipliers 504. Each circuitry module 502 adds the products 510 per column with the adder 512 on each column and then accumulates the sums 516 with the generator 514.

### Example 3: Convolution with Four Instances of Circuitry Module 502

$$Input matrix 4 \times 4 = \begin{matrix}1 & 2 & 3 & 4 & 5 & 6 & 7 & 8 & 9 & 10 & 11 & 12 & 13 & 14 & 15 & 16\end{matrix}$$

$$Kernel 2 \times 2 = \begin{matrix}1 & 0 & 0 & 1\end{matrix}$$

$$Stride = 2$$

$$Top - Left Corner Operation with Circuitry Module I : \begin{matrix}1 & 2 & 5 & 6\end{matrix}$$

$$( 1 * 1 ) + ( 2 * 0 ) + ( 5 * 0 ) + ( 6 * 1 ) = 1 + 0 + 0 + 6 = 7 ; \\ ( element - wise multiply - accumulation with the kernel )$$

Likewise, Top-Right Corner Operation with Circuitry Module II:

$$\begin{matrix}3 & 4 & * & 1 & 0\end{matrix} = 7 ; ( element - wise multiply - accumulation with the kernel )$$

$$7 \qquad 8 \qquad 0 \qquad 1$$

Bottom-Left Corner Operation with Circuitry Module III:

$$\begin{matrix}9 & 10 & * & 1 & 0\end{matrix} = 19 ; \\ ( element - wise multiply - accumulation with the kernel )$$

$$13 \qquad 14 \qquad 0 \qquad 1$$

Bottom-Right Corner Operation with Circuitry Module IV:

$$\begin{matrix}11 & 12 & * & 1 & 0\end{matrix} = 23 ; \\ ( element - wise multiply - accumulation with the kernel )$$

$$15 \qquad 16 \qquad 0 \qquad 1$$

Together, Circuitry Modules I to IV generate the following output matrix:

$$7 \qquad 7$$

$$19 \qquad 23$$

Example 4 demonstrates how the circuitry module 502 can accelerate the attention mechanism. The circuitry module 502 accelerates a softmax calculation by generating good exponential approximations even starting with low precision multiplicands or matrices. Exponential summation can be performed by the main processor with 32-bit floating-point (e.g., binary32 standardized by IEEE 754) supports.

### Example 4: Attention Mechanism, and Softmax Acceleration

```
Q (Query) = [
  [1, 2],
  [3, 1]
]
K (Key) = [
  [2, 1],
  [1, 3]
]
V (Value) = [
  [0.5, 0.8],
  [0.2, 0.7]
]
```

Scaling factor=1/sqrt(d_k), where d_k is a dimension of key vectors (e.g., two in this case)=1/sqrt(2)≈0.7071. This can be pre-computed by the main processor because d_k is known in advance. In real applications, it is common to select a bigger d_k such that the scaling factor is a power of 2.

```
Attention scores = Q * K\hat{ }T =
[
  [1*2 + 2*1, 1*1 + 2*3],
  [3*2 + 1*1, 3*1 + 1*3]
] = [
  [4, 7],
  [7, 6]
]; (Two circuitry modules 502 are utilized.
Each circuitry module 502 is
configured with 2x2 multipliers to generate a
row of the attention scores.)
Scaled attention scores = [
  [4 * 0.7071, 7 * 0.7071],
  [7 * 0.7071, 6 * 0.7071]
] ≈ [
  [2.8284, 4.9497],
  [4.9497, 4.2426]
]; (The circuitry modules 502 perform this scalar
multiplication with adders 512
which generate attention scores and scale the attention
scores based on the scaling
factor - all at once.)
```

Row 1:
e\hat{ }2.8284≈16.9233
e\hat{ }4.9497≈141.1903; (The circuitry module 502 generates both exponential results immediately after the scalar multiplication.)
Sum=16.9233+141.1903=158.1136; (This can be computed by the main processor in 32-bit floating-point.)

Attention weights for row 1:
[16.9233/158.1136, 141.1903/158.1136]≈[0.1070, 0.8930]; (This can be computed by the main processor in 32-bit floating-point.)

Row 2:
e\hat{ }4.9497≈141.1903
e\hat{ }4.2426≈69.5193; (The circuitry module 502 generates both exponential results immediately after the scalar multiplication.)
Sum=141.1903+69.5193=210.7096; (This can be computed by the main processor in 32-bit floating-point.)

Attention weights for row 2:

```
[141.1903 / 210.7096, 69.5193 / 210.7096] ≈
[0.6701, 0.3299] ; (This can be
computed by the main processor in 32-bit floating-point.)
Attention weights matrix:
[
  [0.1070, 0.8930],
  [0.6701, 0.3299]
]; (This can be provided by the main processor
right after the above 32-bit floating-
point computations.)
Output = Attention weights * V
= [
  [0.1070*0.5 + 0.8930*0.2, 0.1070*0.8 + 0.8930*0.7],
  [0.6701*0.5 + 0.3299*0.2, 0.6701*0.8 + 0.3299*0.7]
]
≈ [
  [0.2339, 0.7094],
  [0.4016, 0.7670]
]; (The circuitry modules 502 are utilized.)
```

In this example, two circuitry modules 502 are utilized. Each circuitry module 502 is configured with 2×2 multipliers to generate a row of the attention scores, to scale the row of the attention scores, and to produce a row of the output. However, a three-dimensional (3D) circuitry module with 2×2×2 multipliers can be configured to perform the 2D matrix multiplication and scaling for the 2D scaled attention scores, and also to generate the 2D output. Any 3D rectangular prism or cuboid circuitry modules with same or different sizes on each side are possible as well.

With the generator 514, the circuitry module 502 generates exponential results immediately after the scaled matrix multiplication for the scaled attention scores (or any matrix operations). By fusing the matrix operations with exponential (or activation functions), the circuitry module 502 not only minimizes data movement to save time and energy but also maximizes the computation accuracy by using the original results from the matrix operations which are free from rounding or truncation errors. The circuitry module 502 offers many “Fused Instructions” by combining multiple operations into single, optimized operations to improve energy efficiency, reduce memory usage, accelerate performance, minimize data movement, and/or maximize accuracy. For example, matrix multiplication and exponential function are combined as a single fused instruction. In some cases, residue and/or bias additions, and/or score scaling are additionally integrated together to form an single, optimal fused instruction.

Together, Examples 1 to 4 demonstrate how example implementations accelerate four most computation demanding tasks of modern AI, namely dot products, matrix multiplication, convolution, and attention mechanism, as well as various activation functions. All of this is performed with optimal energy efficiency, such that, AI can be performed locally with inexpensive battery-power devices without sending personal data over the Internet. As such, example implementations help preserve data security, personal privacy, and our environment.

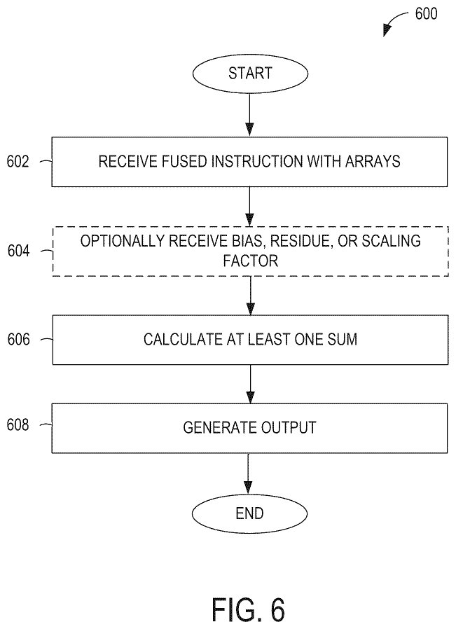

FIG. 6 illustrates an exemplary, simplified method 600 to accelerate computations, in accordance with example implementations. Operations in the method 600 may be performed by the simplified integrated circuit 500 comprising the circuitry module 502 described above with respect to FIG. 5. Accordingly, the method 600 is described by way of example with reference to the circuitry module 502. However, it shall be appreciated that at least some of the operations of the method 600 may be performed by similar components of other integrated circuits.

In operation 602, a fused instruction along is received by the integrated circuit 502. In example implementations, the fused instruction triggers the integrated circuit 502 to execute the instructions as a single instruction rather than a combination of at least two instructions. As discussed above, the circuitry module 502 offers many “Fused Instructions” by combining multiple operations into single, optimized operations to improve energy efficiency, reduce memory usage, accelerate performance, minimize data movement, and/or maximize accuracy. For example, matrix multiplication and exponential function can be combined as a single fused instructions. In some cases, residue and/or bias additions, and/or score scaling are additionally integrated together to form an single, optimal fused instruction.

Additionally, the circuitry module 502 receives two input values with the fused instructions in operation 602. For example, the circuitry module 502 can receive a first array from the m1_main bus 506 and a second array from the m2_main bus 508.

A fused operation is then performed in response to the fused instruction. The fused operation comprises both operations 606 and 608. In operation 606, the circuitry module 502 calculates at least one sum 516. In example implementations, the circuitry module 502 uses the multipliers 504 and adders 512 to calculate the at least one sum 516. Operation 606 can include any of the following: 1. Calculating a dot product (e.g., multiplying corresponding elements of two arrays and then summing the results). 2. Performing matrix multiplication (e.g., multiplying two matrices together). 3. Conducting a convolution (e.g., a mathematical operation used in convolutional neural networks (CNNs), signal processing, and image processing). 4. Calculating attention scores (e.g., used in attention mechanisms within neural networks such as, for example, Transformers, Generative Pre-trained Transformers (GPTs), Large Language Models (LLMs), and generative AI). In simpler terms, different specific types of calculations can be applied to find the at least one sum 516 (e.g., multiplying elements of arrays, multiplying matrices, performing convolutions, or computing attention scores).

In operation 608, the circuitry module 502 generates the output 518. In example implementations, the generator 514 generates the output 518 using the at least one sum 516 calculated in operation 606. Operation 608 can involve any of the following: 1. Adding up or averaging the at least one sum 516. 2. Applying an activation function based on the at least one sum 516. 3. Approximating an exponential function using the at least one sum 516. 4. Sorting the at least one sum 516 according to their numerical values. 5. Converting the at least one sum 516 to a predetermined format. In simpler terms, different specific ways can be applied to produce the final result 518, such as adding or averaging the at least one sum 516, applying a function that changes the at least one sum 516 in a specific way, approximating an exponential function, or sorting the at least one sum 516 by their values.

Optionally, the circuitry module 502 can additionally receive an adjustment in operation 604 (e.g., from an unshown, optional addend bus and/or an adjustment(s) input). The adjustment can include, for example, a bias, a residue, and/or a scaling factor. In these cases, calculating the at least one sum 516, in operation 606, can further involve any of the following: 1. Scaling the attention scores. 2. Adding a bias. 3. Adding a residue. In simpler terms, the at least one sum 516 calculations can involve either adjusting the attention scores by scaling them or adding an extra value (e.g., bias and/or residue) to the calculations. The circuitry module 502 may utilize multi-input adders (instead of 2-input adders 512) and produce the at least one sum 516 based on the input arrays (e.g., from the M1_bus 506 and the M2_bus 508) and the residue, the bias and/or the scaling factor. In this case, the at least one sum 516 will include the bias and/or the residue, and/or be adjusted by the scaling factor.

FIG. 6 shows receiving the bias, the residue, and/or the scaling factor in operation 604 occurring after receiving the arrays (operation 602) and before the calculation of the at least one sum (606). An alternative implementation can receive the bias, the residue, and/or the scaling factor, before or at the same time as receiving the arrays in operation 602. A further implementation can receive the bias, the residue, and/or the scaling factor, during or after the calculation of the at least one sum in operation 606. Further still, the bias, the residue, and the scaling factor do not have to be received at the same time. The method 600 remains functional with many various sequences.

Conventional systems spend significant time and energy to perform matrix operations (e.g., matrix multiplication), waste even more time/energy to store the intermediate results (e.g., dot products), waste further time/energy to load the intermediate results back, and consume significant time and energy again to perform activation function (e.g., exponential). Conventional systems also cause rounding errors by converting the intermediate results to fit memory bandwidth and/or format requirements. As such, AI models have been experiencing memory bottleneck, long latency, high power consumption, and accuracy issues.

Example implementations provide tangible benefits such as enhanced response accuracy, faster processing, and local private battery-based AI applications, making conversational agents like ChatGPT more secure and personalized for end-users. Some implementations (e.g., matrix multiply-adder 302 of FIG. 3) perform, for example, dot product, matrix multiply, attention mechanism, and other common AI operations with little latency and little power consumption. Some implementations (e.g., post-processor 402 of FIG. 4) perform exponential and other activation functions with minimized latency and energy requirements. By tightly coupling multipliers (e.g., multipliers 504 of FIG. 5), adders (e.g., adders 512 of FIG. 5), and a generator (e.g., generator 514 of FIG. 5) without any memory or storage in between, some implementations are highly integrated circuitries (e.g., circuitry module 502 of FIG. 5) capable of performing various fused instructions with low latency and low energy consumption. The integrated circuitries (e.g., matrix multiply-adder 302 of FIG. 3, post-processor 402 of FIG. 4, and circuitry module 502 of FIG. 5) are scalable modules and can be instantiated multiple times in accordance with various throughput requirements, suitable for diverse AI and other workloads.

The method 600 defeats the memory bottleneck by combining operations 606 and 608 into a single fused instruction utilizing tightly coupled hardware elements (e.g., multipliers 504, adders 512, and generator 514 in FIG. 5) and eliminating the slow and power-hungry processes of storing and loading intermediate results (e.g., attention scores and scaled attention scores in Example 4). Example implementations deliver more accurate results (e.g., exponential results in Example 4) by computing based on the original intermediate results (e.g., scaled attention scores in Example 4) which are free from rounding or other errors.

The method 600 can be repeatedly deployed for various network layers within a deep neural network, significantly enhancing the AI model performance and user experience. The final output from the method 600 can be stored in a hardware resource (e.g., buffer, scratchpad, register file, cache, memory) and/or shared with a main processor. For example, in a ChatGPT application, after the self-attention mechanism is optimized based on the method 600, the main processor uses the output from the method 600 to prioritize relevant information and deliver more accurate and contextually appropriate responses to end-users.

Fused instructions are also known as “fused operations,” “combined instructions,” etc. Example implementations support at least the following fused instructions: 1. Multiply-add; 2. Dot product; 3. Matrix multiplication; 4. Matrix multiplication and bias addition; 5. Matrix multiplication and residue addition; 6. Matrix multiplication, bias and residue additions; 7. Dot product and activation function; 8. Matrix multiplication and activation function; 9. Matrix multiplication, bias addition and activation function; 10. Matrix multiplication, residue addition and activation function; 11. Matrix multiplication, bias and residue additions, and activation function; 12. Convolution; 13. Convolution and bias addition; 14. Convolution and residue addition; 15. Convolution, bias and residue additions; 16. Convolution and activation function; 17. Convolution, bias addition and activation function; 18. Convolution, residue addition and activation function; 19. Convolution, bias and residue additions, and activation function; 20. Attention mechanism; 21. Attention scores; 22. Scaled attention scores; 23. Exponential function; 24. Attention mechanism and bias addition; 25. Attention scores and bias addition; 26. Scaled attention scores and bias addition; 27. Attention mechanism and residue addition; 28. Attention scores and residue addition; 29. Scaled attention scores and residue addition; 30. Attention mechanism and both bias and residue additions; 31. Attention scores and both bias and residue additions; 32. Scaled attention scores and both bias and residue additions; 33. Attention mechanism, bias addition, and factor scaling; 34. Attention scores, bias addition, and factor scaling; 35. Scaled attention scores and bias addition; 36. Attention mechanism, residue addition, and factor scaling; 37. Attention scores, residue addition, and factor scaling; 38. Attention mechanism and Exponential; 39. Attention scores and Exponential; 40. Scaled attention scores and Exponential; 41. Attention mechanism, bias addition, and Exponential; 42. Attention scores, bias addition, and Exponential; 43. Scaled attention scores, bias addition, and Exponential; 44. Attention mechanism, residue addition, and Exponential; 45. Attention scores, residue addition, and Exponential; 46. Scaled attention scores, residue addition, and Exponential; 47. Attention mechanism, both bias and residue additions, and Exponential; 48. Attention scores, both bias and residue additions, and Exponential; 49. Scaled attention scores, both bias and residue additions, and Exponential; 50. Attention mechanism, bias addition, factor scaling, and Exponential; 51. Attention scores, bias addition, factor scaling, and Exponential; 52. Scaled attention scores, bias addition, and Exponential; 53. Attention mechanism, residue addition, factor scaling, and Exponential; 54. Attention scores, residue addition, factor scaling, and Exponential; 55. Convolution and sampling (by sorting or summing the at least one sum 516, for example); 56. Convolution, bias addition, and sampling; 57. Convolution, residue addition, and sampling; and 58. Convolution, both bias and residue additions, and sampling.

An example implementation can select one or more of the following standards or specifications: IEEE Std 754, OCP Microscaling Formats (MX) Specification, IEEE Std 3109, a de facto standard, and/or a proprietary definition. For example, IEEE Std 754 standardizes the encoding of zero, numeric values, infinities, and non-numeric for each defined format. An example implementation can utilize these standardized encodings as predetermined constants to interpret floating-point representations. If a selected document does not encode a particular value (e.g., the OCP MX Spec does not encode infinities in their E4M3 data type), an example implementation can assume that the unencoded value will not occur when interpreting input values. Some documents use “format,” while others use “type” or “data type” instead. Example implementations consider “format,” “type,” and “data type” interchangeable.

Each and every element exemplified herein can be converted into a standardized hardware description language (e.g., Verilog as defined by IEEE Std 1364). The description language can then be synthesized into a physical implementation using a technology-specific standard cell library as well as synthesis and layout tools (e.g., Icarus Verilog). For example, a CMOS integrated circuit standard cell library developed by Virginia Tech for VLSI and Telecommunication Lab (VTVT) for a TSMC 0.25 um manufacturing process is one such library. A semiconductor chip manufacturer (e.g., TSMC) can then fabricate silicon chips according to the physical implementation.

Example 5 exemplifies a Verilog code representing the selector 120 of FIG. 1. BF16 floating-point format is selected for all inputs and the output value. The output “skip_multiplication” can be used to skip the corresponding multiplication, while the output “skip_addition” can be used to skip the corresponding addition, to further reduce energy consumption.

### Example 5: Exemplified Embodiment in a Standardized Language

```
module selector (
  input [15:0] multiplicand1, // 16-bit BF16 floating-point inputs
  input [15:0] multiplicand2,
  input [15:0] addend,
  input [15:0] product,
  input [15:0] sum,
  output reg [15:0] output_val,
  output reg skip_multiplication,
  output reg skip_addition
):
  // Function to check if the input is NaN
  function is_nan;
    input [15:0] val;
    begin
      is_nan = (val[14:7] == 8′b11111111) &&
      (val[6:0] != 0);
    end
  endfunction
  // Function to check if the input is zero
  function is_zero;
    input [15:0] val;
    begin
      is_zero = (val[14:0] == 0);
    end
  endfunction
  // Function to check if the input is infinity
  function is_infinity;
    input [15:0] val;
    begin
      is_infinity = (val[14:7] ==
      8′b11111111) &&(val[6:0] == 0);
    end
  endfunction
  // Function to check if the input is finite
  function is_finite;
    input [15:0] val;
    begin
      is_finite = (val[14:7] != 8′b11111111);
    end
  endfunction
  always @(*) begin
    // Default values
    skip_multiplication = 1′b0;
    skip_addition = 1′b0;
    if (is_nan(multiplicand1) ∥ is_nan(multiplicand2) ∥
    is_nan(addend)) begin
      output_val = (is_nan(multiplicand1)) ? multiplicand1 :
        (is_nan(multiplicand2)) ? multiplicand2 : addend;
      skip_multiplication = 1′b1;
      skip_addition = 1′b1;
    end else if ((is_zero(multiplicand1) && is_finite(multiplicand2)) ∥
(is_zero(multiplicand2) && is_finite(multiplicand1))) begin
      output_val = addend;
      skip_multiplication = 1′b1;
      skip_addition = 1′b1;
    end else if (is_zero(addend)) begin
      output_val = product;
      skip_addition = 1′b1;
    end else if (is_infinity(product) && is_finite(addend)) begin
      output_val = product;
      skip_addition = 1′b1;
    end else begin
      output_val = sum;
    end
  end
endmodule
```

Example 6 is an example of what part of the synthesized netlist (selector_synthesized.v) may look like. Generated by a typical synthesis tool, the netlist is suitable for physical layout, additional backend processes, and physical manufacturing of the integrated circuit.

### Example 6: Part of Synthesized Netlist

```
module selector (
  multiplicand1,
  multiplicand2,
  addend,
  product,
  sum,
  output_val,
  skip_multiplication,
  skip_addition
);
  input [15:0] multiplicand1;
  input [15:0] multiplicand2;
  input [15:0] addend;
  input [15:0] product;
  input [15:0] sum;
  output [15:0] output_val;
  output skip_multiplication;
  output skip_addition;
  // Example synthesized gates (these will vary based
  on the library and constraints)
  wire n1, n2, n3, n4;
  AND2X1 U1 (.A(multiplicand1[14]), .B(multiplicand1[7]), .Y(n1));
  OR2X1 U2(.A(n1), .B(multiplicand2[14]), .Y(n2));
  NOTX1 U3 (.A(addend[14]), .Y(n3));
  NAND2X1 U4 (.A(product[14]), .B(sum[14]), .Y(n4));
  // Output logic
  assign output_val = n4 ? sum : product;
  assign skip_multiplication = n2;
  assign skip_addition = n3;
endmodule
```

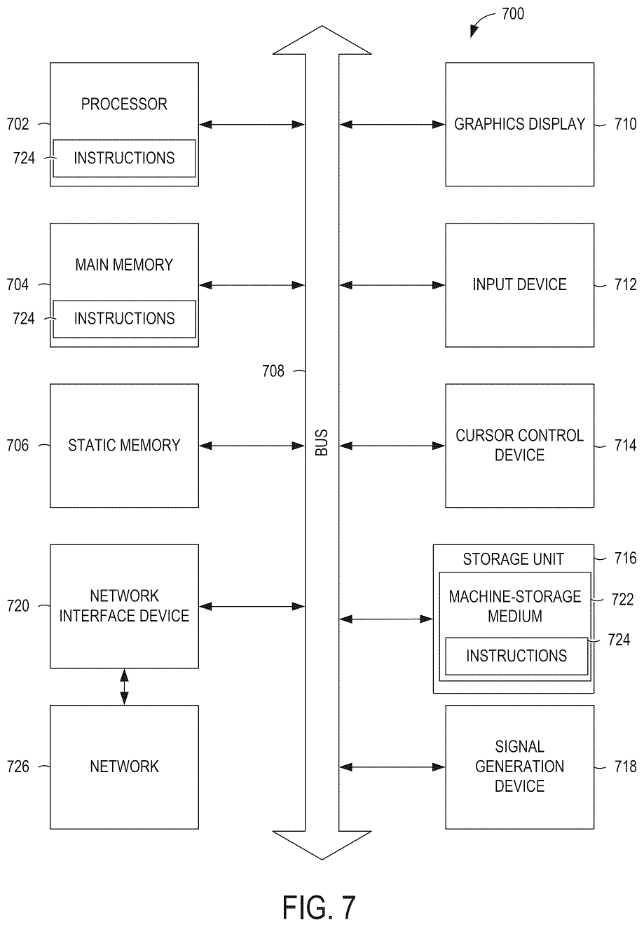

The output of the integrated circuits of FIG. 1 through FIG. 5 can be stored to a hardware resource, shared with a main processor, and/or outputted (e.g., displayed on or used by a computer). The computer may be the device that triggered (e.g., provide instructions(s) to) the integrated circuits to generate the output. In example implementations, any of the components shown in, or associated with the integrated circuits of FIG. 1 through FIG. 5 can be, comprise, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

FIG. 7 illustrates components of a machine 700, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein can be executed, in whole or in part. In one implementation, the instructions 724 can transform the machine 700 into a particular machine (e.g., specially configured machine) programmed to carry out the described and illustrated functions in the manner described.

In alternative implementations, the machine 700 operates as a standalone device or can be connected (e.g., networked) to other machines. In a networked deployment, the machine 700 can operate in the capacity of a server machine or a client machine in a server-client network environment, or as a peer machine in a peer-to-peer (or distributed) network environment. The machine 700 can be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 can contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 can be configurable to execute one or more components described herein.

The machine 700 can further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 can also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 can also reside, completely or at least partially, within the main memory 704, within the processor 702 (e.g., within the processor's cache memory), or both, before or during execution thereof by the machine 700. Accordingly, the main memory 704 and the processor 702 can be considered as machine-storage media (e.g., tangible and non-transitory machine-storage media). The instructions 724 can be transmitted or received over a network 726 via the network interface device 720.

In some example implementations, the machine 700 can be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components can be accessible and available for use by any of the components described herein.

### Executable Instructions and Machine-Storage Medium

The various memories (e.g., 704, 706, and/or memory of the processor(s) 702) and/or storage unit 716 can store one or more sets of instructions and data structures (e.g., software) 724 embodying or utilized by any one or more of the methodologies or functions described herein. These instructions, when executed by processor(s) 702 cause various operations to implement the disclosed implementations.

As used herein, the terms “machine-storage medium,” “device-storage medium,” “computer-storage medium” (referred to collectively as “machine-storage medium 722”) mean the same thing and can be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and can be used interchangeably in this disclosure. The terms are defined to include both machine-storage media and signal media. Thus, the terms include both storage devices/media and carrier waves/modulated data signals.

The instructions 724 can further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components.

A “hardware component” is a tangible unit capable of performing certain operations and can be configured or arranged in a certain physical manner. In various example implementations, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein.

In some implementations, a hardware component can be implemented mechanically, electronically, or any suitable combination thereof. For example, a hardware component can include dedicated circuitry or logic that is permanently configured to perform certain operations. For example, a hardware component can be a special-purpose processor, such as a field programmable gate array (FPGA) or an ASIC. A hardware component can also include programmable logic or circuitry that is temporarily configured by software to perform certain operations. For example, a hardware component can include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor can be configured as respectively different special-purpose processors (e.g., comprising different hardware components) at different times. Software can accordingly configure a processor, for example, to constitute a particular hardware component at one instance of time and to constitute a different hardware component at a different instance of time.

Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” refers to a hardware component implemented using one or more processors.

Similarly, the methods described herein can be at least partially processor-implemented, a processor being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an application program interface (API)).

The performance of certain of the operations can be distributed among the one or more processors, not only residing within a single machine, but deployed across a number of machines. In some example implementations, the one or more processors or processor-implemented components can be located in a single geographic location (e.g., within a home environment, an office environment, or a server farm). In other example implementations, the one or more processors or processor-implemented components can be distributed across a number of geographic locations.

### Examples

Example 1 is an integrated circuit comprising a multiply-adder configured to receive a first multiplicand, a second multiplicand, and an addend and to perform an operation to generate an output. The multiply-adder comprises a multiplier that multiplies the first multiplicand with the second multiplicand to generate a product; an adder that adds the product with the addend to generate a sum; and a selector that selects the output based on whether the first multiplicand, the second multiplicand, and/or the addend is zero, infinity, non-numeric, or finite non-zero.

In example 2, the subject matter of example 1 can optionally include wherein the first multiplicand is a floating-point number and the second multiplicand is an integer number, or vice versa.

In example 3, the subject matter of any of examples 1-2 can optionally include wherein the first multiplicand, the second multiplicand, or both is/are an unsigned floating-point number comprising an exponent field and a significand field.

In example 4, the subject matter of any of examples 1-3 can optionally include wherein the addend is an integer number.

In example 5, the subject matter of any of examples 1˜4 can optionally include wherein a precision of the output is equal to a precision of the addend.

In example 6, the subject matter of any of examples 1-5 can optionally include wherein the first multiplicand is a floating-point number with a first precision and the second multiplicand is a floating-point number with a second precision which differs from the first precision.

In example 7, the subject matter of any of examples 1-6 can optionally include wherein a precision of the output is higher than precisions of the first multiplicand and the second multiplicand.

In example 8, the subject matter of any of examples 1-7 can optionally include wherein the output is an integer number representing an exact mathematical result without an error.

In example 9, the subject matter of any of examples 1-8 can optionally include wherein the output represents only zero, finite, or non-numeric.

In example 10, the subject matter of any of examples 1-9 can optionally include one or more additional multiply-adders chained to the multiply-adder to form a chained multiply-adder.

In example 11, the subject matter of any of examples 1-10 can optionally include one or more additional chained multiply-adders arranged with the chained multiply-adder to form a matrix multiply-adder.

In example 12, the subject matter of any of examples 1-11 can optionally include a post-processor configured to perform residue addition, bias addition, and/or attention score scaling.

Example 13 is an integrated circuit comprising a post-processor configured to receive at least two inputs from an input bus and an adjustment and to perform an operation to generate an output. The post-processor comprises at least two adders that receive the at least two inputs and the adjustment, the at least two adders configured to generate at least two sums; and a generator that generates the output based on the at least two sums.

In example 14, the subject matter of example 13 can optionally include wherein the at least two adders generate the at least two sums by either adjusting an exponent of at least one of the at least two inputs based on the adjustment, adding the adjustment to at least one of the at least two inputs, forwarding the at least two inputs, or forwarding the adjustment.

In example 15, the subject matter of any of examples 13-14 can optionally include wherein the output comprises at least two outputs and the generator generates the at least two outputs by performing any of truncating the at least two sums; rounding the at least two sums; looking up a predetermined table based on the at least two sums; estimating a predetermined function based on the at least two sums; filtering the at least two sums; negating the at least; converting the at least two sums into a different format; resetting any sign bits of the at least two sums; or forwarding the at least two sums.

In example 16, the subject matter of any of examples 13-15 can optionally include wherein the generator generates the output by sorting the at least two sums based on their numerical values.

In example 17, the subject matter of any of examples 13-16 can optionally include wherein the generator generates the output by summing the at least two sums or by averaging the at least two sums.

In example 18, the subject matter of any of examples 13-17 can optionally include wherein the generator generates the output by transposing, permuting, shuffling, sampling, or forwarding the at least two sums.

In example 19, the subject matter of any of examples 13-18 can optionally include wherein the generator generates only zero, finite, or non-numeric.

In example 20, the subject matter of any of examples 13-19 can optionally include wherein the adjustment and the output are of a same format.

Some portions of this specification can be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities can take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like can refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes can be made to these examples without departing from the broader scope of examples of the present invention. For instance, various examples or features thereof can be mixed and matched or made optional by a person of ordinary skill in the art. Such examples of the present subject matter can be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples can be used and derived therefrom, such that structural and logical substitutions and changes can be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various examples of the present invention. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. An integrated circuit comprising:
a multiply-adder configured to receive a first multiplicand, a second multiplicand, and an addend and to perform an operation to generate an output, the multiply-adder comprising:
a multiplier that multiplies the first multiplicand with the second multiplicand to generate a product;
an adder that adds the product with the addend to generate a sum; and
a selector that selects the output based on whether the first multiplicand, the second multiplicand, and/or the addend is zero, infinity, non-numeric, or finite non-zero.

2. The integrated circuit of claim 1, wherein the first multiplicand is a floating-point number and the second multiplicand is an integer number, or vice versa.

3. The integrated circuit of claim 1, wherein the first multiplicand, the second multiplicand, or both is/are an unsigned floating-point number comprising an exponent field and a significand field.

4. The integrated circuit of claim 1, wherein the addend is an integer number.

5. The integrated circuit of claim 1, wherein a precision of the output is equal to a precision of the addend.

6. The integrated circuit of claim 1, wherein the first multiplicand is a floating-point number with a first precision and the second multiplicand is a floating-point number with a second precision which differs from the first precision.

7. The integrated circuit of claim 1, wherein a precision of the output is higher than precisions of the first multiplicand and the second multiplicand.

8. The integrated circuit of claim 1, wherein the output is an integer number representing an exact mathematical result without an error.

9. The integrated circuit of claim 1, wherein the output represents only zero, finite, or non-numeric.

10. The integrated circuit of claim 1, further comprising:
one or more additional multiply-adders chained to the multiply-adder to form a chained multiply-adder.

11. The integrated circuit of claim 10, further comprising:
one or more additional chained multiply-adders arranged with the chained multiply-adder to form a matrix multiply-adder.

12. The integrated circuit of claim 1, further comprising:
a post-processor configured to perform residue addition, bias addition, and/or attention score scaling.

13. An integrated circuit comprising:
a post-processor configured to receive at least two inputs from an input bus and an adjustment and to perform an operation to generate an output, the post-processor comprising:
at least two adders that receive the at least two inputs and the adjustment, the at least two adders configured to generate at least two sums; and
a generator that generates the output based on the at least two sums.

14. The integrated circuit of claim 13, wherein the at least two adders generate the at least two sums by either adjusting an exponent of at least one of the at least two inputs based on the adjustment, adding the adjustment to at least one of the at least two inputs, forwarding the at least two inputs, or forwarding the adjustment.

15. The integrated circuit of claim 13, wherein the output comprises at least two outputs and the generator generates the at least two outputs by performing any of:
truncating the at least two sums;
rounding the at least two sums;
looking up a predetermined table based on the at least two sums;
estimating a predetermined function based on the at least two sums;
filtering the at least two sums;
negating the at least two sums;
converting the at least two sums into a different format;
resetting any sign bits of the at least two sums; or
forwarding the at least two sums.

16. The integrated circuit of claim 13, wherein the generator generates the output by sorting the at least two sums based on their numerical values.

17. The integrated circuit of claim 13, wherein the generator generates the output by summing the at least two sums or by averaging the at least two sums.

18. The integrated circuit of claim 13, wherein the generator generates the output by transposing, permuting, shuffling, sampling, or forwarding the at least two sums.

19. The integrated circuit of claim 13, wherein the generator generates only zero, finite, or non-numeric.

20. The integrated circuit of claim 13, wherein the adjustment and the output are of a same format.
